(19) United States
(12) Patent Application Publication
(10) Pub. No.: US 2007/0043604 A1
(43) Pub. Date: Feb. 22, 2007

(54) Methods and systems to obtain a relative frequency distribution describing a distribution of counts

(75) Inventor: Donald C. Lewis, Bell Buckle, TN (US)

Correspondence Address: WELSH & KATZ, LTD, 120 S RIVERSIDE PLAZA, 22ND FLOOR, CHICAGO, IL, 60606, US

(73) Assignee: Aspect Communications Corporation

(21) Appl. No.: 11/210,047

(22) Filed: Aug. 22, 2005

(51) Int. Cl. G06F 9/46

(52) U.S. Cl. 705/9

(57) ABSTRACT

A method and system to obtain relative frequency distributions to forecast counts used in worker scheduling are described herein. The method includes calculating a plurality of square roots of count data associated with a sequence of the plurality of intervals; extracting a number of amplitudes associated with a plurality of count distributions from the calculated plurality of square roots; calculating a number of counts associated with each amplitude over the plurality of intervals; and squaring the extracted number of amplitudes to obtain a corresponding plurality of estimates of relative frequency distributions describing the distribution of the calculated number of counts over the plurality of intervals.

### FIELD

The application relates generally to the field of data processing, and in one example embodiment to methods and systems to obtain a relative frequency distribution describing a distribution of counts over a plurality of intervals, and to a machine-readable medium comprising instructions to perform this method.

### BACKGROUND

Automatic Call Distribution (ACD) centers often use forecasting models to forecast contacts, or calls, during certain periods of time. The forecasting models may be useful in determining adequate and efficient staff scheduling, for instance.

### SUMMARY

According to an aspect of the invention there is provided a computer-implemented method and system to obtain relative frequency distributions to forecast counts used in worker scheduling are described herein. The computer-implemented method includes calculating a plurality of square roots of count data associated with a sequence of a plurality of intervals; extracting a number of amplitudes associated with a plurality of count distributions from the calculated plurality of square roots; calculating a number of counts associated with each amplitude over the plurality of intervals; and squaring the extracted number of amplitudes to obtain a corresponding plurality of estimates of relative frequency distributions describing the distribution of the calculated number of counts over the plurality of intervals.

### BRIEF DESCRIPTION OF DRAWINGS

This patent or application file contains at least one drawing executed in color. Copies of this patent or patent application publication with color drawings will be provided by the Office upon request and payment of the necessary fee.

An example embodiment of the present invention is illustrated by way of example and not limitation in the figures of the accompanying drawings, in which like references indicate similar elements and in which:

FIG. 1 illustrates a system, according to an example embodiment.

FIG. 2 illustrates a method of obtaining a relative frequency distribution, according to an embodiment.

FIG. 3 illustrates a graphical representation of counts in an example implementation.

FIG. 4 illustrates another graphical representation of counts in an example implementation.

FIG. 5 illustrates a graphical representation of count amplitude versus day of the week in an example implementation.

FIG. 6 illustrates a graphical representation of amplitudes versus day of the week in an example implementation.

FIG. 7 illustrates a graphical representation of day of week probability distributions obtained from amplitudes in an example implementation.

FIG. 8 illustrates a graphical representation of coefficients of amplitudes in an example implementation.

FIG. 9 illustrates a graphical representation of dominant day of week amplitudes in an example implementation.

FIG. 10 illustrates a graphical representation of approximate count amplitudes in an example implementation.

FIGS. 11 and 12 illustrate a graphical representation of approximate counts in an example implementation.

FIG. 13 illustrates a graphical representation of approximate counts from select amplitudes in an example implementation.

FIG. 14 shows a diagrammatic representation of machine in the example form of a computer system within which a set of instructions, for causing the machine to perform any one or more of the methodologies discussed herein, may be executed.

### DETAILED DESCRIPTION

According to an aspect of the invention there is provided a method and system to obtain relative frequency distributions to forecast counts used in worker scheduling are described herein. The method includes calculating a plurality of square roots of count data associated with a sequence of a plurality of intervals; extracting a number of amplitudes associated with a plurality of count distributions from the calculated plurality of square roots; calculating a number of counts associated with each amplitude over the plurality of intervals; and squaring the extracted number of amplitudes to obtain a corresponding plurality of estimates of relative frequency distributions describing the distribution of the calculated number of counts over the plurality of intervals.

In an implementation, contacts may include calls or other electronic contacts. In the implementation, a method estimates a probability distribution describing the conditional probability that a call (or other electronic contact) may arrive on a given day (or 1^{st} time period) of a week (or 2^{nd} time period), given the call arrives some day in the particular week. The estimate may be based on a month (or 3^{rd} time period) or several weeks of data for call counts for each day of the month, and the single estimate is to reflect a pattern of distribution, which is common to each week of the month.

The probability distribution describing the conditional probability that a call (or other electronic contact) may arrive on a given day of a week, for instance, given the call arrives some day in the particular week may also be known as a forecasting model, which may be useful in determining adequate and efficient staff scheduling during that week, for instance.

Architecture

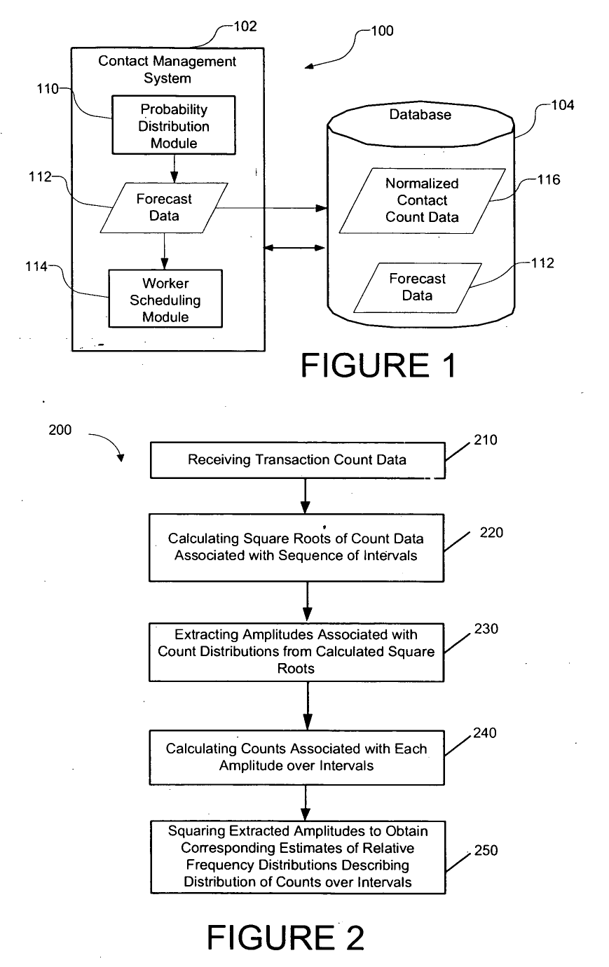

FIG. 1 illustrates a system 100, according to an example embodiment of the present invention. The system 100 includes a contact management system 102 and a database 104. The contact management system 102 may include a probability distribution module 110. The probability distribution module 110 may produce forecast data 112. The forecast data 112 may be saved in the database 104 and may be used in the worker scheduling module 114.

The probability distribution module 110 receives normalized contact count data 116 from the database 104 regarding count or contact data over a period of time, for example days, for a particular interval, for example, a week. For each valid data entry in the interval, the data may be a non-negative number. The probability distribution module 110 may receive data 116 associated with a plurality of intervals.

The worker scheduling module 114 may determine staff scheduling during a time interval associated with the forecast data.

FIG. 2 illustrates a computer-implemented method 200 of obtaining a probability distribution describing distribution of counts, according to an embodiment. In an embodiment, the computer-implemented method 200 describes how the probability distribution module 110 of FIG. 1 produces forecast data 112.

At block 210, contact count data 116 may be received as input of a plurality of normalized counts, for example, daily values, for a plurality of intervals, for example, weeks. The contact count data may be represented in a first matrix. The counts may be selected from a group including events, transactions, requests for service, contacts arriving at a system for handling contacts, and arriving customers. The plurality of intervals may be selected from a group including intervals of time, intervals of space, intervals of cyber-space, business abstractions that can be formulated as measurable subsets in a measured space, and subsets in a space of business abstractions, which abstractions are used to at least one of describe, define, and classify different types of counts. The plurality of intervals may be mathematically ordered pairs of any two from the group, or more generally, an ordered n-tuple of any number of types of intervals of the group.

The plurality of intervals may be associated with intervals of time and each time interval may be of substantially constant duration, wherein each time interval is organized into a same number of blocks. The numbers of the amplitude may be squared for each interval of a block to give the relative frequency with which counts assigned to that amplitude occur on that interval of a block. Each time interval may be selected from a period of a day, a day, a period of a week, a week, a period of a month, and a month. The sequence of the plurality of intervals may include a Cartesian product of two selected from a group including a set of time intervals, a set of locations, and a set of locations in cyber-space, a type of count, a set of types that defines a classification of different kinds of counts, a measurable set in a first measure space and a measurable set in a second measure space. Measurable sets and measure spaces are general and abstract mathematical settings for the situation where each cell in a rectangular table at some row and column position corresponds to an ordered pair of (measurable) sets. The first member of the pair is from the first measure space (corresponding to the row) and the second member of the pair is from a second measure space (corresponding to a column.) Measurable sets in a measure space are sets that may have magnitudes (counts, for example) associated with them, and where these magnitudes follow the natural laws of addition for sets.

At block 220, a square root of contact count data associated with a sequence of intervals may be calculated. The sequence may be finite. The square root may be taken of each of the data entries of the contact count data of block 210 and may be represented in a second matrix.

At block 230, amplitudes for count distributions may be extracted from the calculated square root. In an implementation, the transpose of the second matrix may be multiplied by the second matrix to represent a third matrix. In an implementation, a type of eigenvalue/eigenvector mathematical problem is solved for eigenvectors (e.g., amplitudes) and corresponding eigenvalues, which may be considered the number of counts associated with respective amplitudes.

At block 240, a number of counts (e.g., eigenvalues) associated with each amplitude over the sequence of generalized intervals may be calculated. Each of the calculated counts of the number of calculated counts includes a total number of counts, due to the respective amplitude, summed over the sequence.

At block 250, the extracted number of amplitudes (e.g., eigenvectors) may be squared to obtain a corresponding plurality of estimates of relative frequency distributions describing the distribution of the calculated number of counts over the plurality of intervals.

Further, the plurality of estimates of the relative frequency distributions may be normalized to obtain estimates of probability distributions describing distribution of the calculated number of counts over the plurality of intervals. Normalizing the relative frequency distributions may include dividing each of the numbers of the amplitude by a positive constant to obtain another set of numbers, wherein the numbers of the probability distribution sum to one. The amplitude may be selected to render normalization as substantially dispensable.

Example Computation of Probability Distribution

Let mᵢⱼ be the input data on the j^{th} day of the i^{th} week. In this example, there are 7 days in this week. Let M denote the matrix formed from elements mᵢⱼ. In this embodiment, mᵢⱼ>0 for each i and j . aᵢⱼ may be defined by the rule aᵢⱼ=\sqrt{mᵢⱼ}, and A may denote the matrix formed from the elements aᵢⱼ. The matrix, A, is called the amplitude of the month. A^{T} is the transpose of A.

The computational heart of the extraction of the dominant day of week distribution is solving the mathematical eigenvalue-eigenvector problem: A^{T}Aνᵢ=λᵢνᵢ. The numerical technique sometimes known as “the power method” may be sufficient and appropriate in this implementation to solve the mathematical eigenvalue-eigenvector problem.

The eigenvector(s) and corresponding eigenvalue(s) are solved for, and the components of the dominant day of week distribution, dⱼ, are then given by dⱼ=(ν₁ⱼ)² for j=1, 2, . . . , 7, for each eigenvector, as appropriate.

Example Extraction Distribution

The matrix A^{T} A may be a real, symmetric, 7 by 7 matrix. Each eigenvalue of matrix A^{T} A may be real and non-negative. Matrix A^{T} A may have a set of seven orthonormal eigenvectors. There are seven numbers, λ₁, λ₂, . . . , λ₇, (the eigenvalues) which can be ordered so that λᵢ≧λⱼ whenever i≦j. There is a set of seven vectors, {ν₁,ν₂, . . . ,ν₇} in R⁷, (containing the eigenvectors), which is both orthogonal, in that νᵢ·νⱼ=0 whenever i≠j, and normalized, in that vᵢ·νᵢ=1. The corresponding eigenvalues and eigenvectors are related in that A^{T} Aνᵢ=λᵢνᵢ.

Each eigenvector in the set corresponds to a different (and independent) day of week distribution. The associated eigenvalue measures the volume of contacts (e.g., calls) that follow that distribution. In particular,

$${\sum }_{ij} {m}_{ij} = {\sum }_{k} {λ}_{k} .$$

The total monthly call volume may be substantially equal to the sum of the eigenvalues of A^{T} A .

In an implementation, the eigenvalue λ₁ may be called the dominant eigenvalue because it is the largest eigenvalue and the greatest number of calls follow the distribution of its eigenvector. The eigenvector ν₁ may then be called the dominant eigenvector. Let λ₁ⱼ denote the j^{th} component of the vector ν₁. The components of the dominant day of week distribution, dⱼ, are then given by dⱼ=(ν₁ⱼ)²for j=1,2, . . . , 7. By comparing the dominant eigenvalue to the total monthly call volume, one can determine how well a particular month of normalized data is represented by a single day of week pattern. Similar comparisons can be made with two and three amplitudes, etc., as described herein.

A technique to solve the eigenvalue-eigenvector problem: A^{T} Aνᵢ=λᵢνᵢ is based on the following: z₁,z₂, . . . ,zₙ, . . . may be assumed to be a sequence of vectors in R⁷ defined by the recursion:

$${z}_{n + 1} = {A}^{T} A ( \frac{{z}_{n}}{‖ {z}_{n} ‖} ) ,$$

where ∥zₙ∥=\sqrt{zₙ·zₙ} and where z₁ is a random vector in R⁷ such that ∥z∥=1. In other words, let z₁ be a random variable that is uniformly distributed over the unit sphere in R⁷. Then the probability is 1 that

$$\frac{{z}_{n}}{‖ {z}_{n} ‖}$$

converges to a dominant eigenvector of A^{T} A.

Therefore, for large n,

$$\frac{{z}_{n}}{‖ {z}_{n} ‖}$$

is almost certainly an approximation to a dominant eigenvector of A^{T} A and the corresponding eigenvalue is approximated by ∥zₙ₊₁∥.

A dominant eigenvector of A^{T} A is a vector, ν, that (globally) maximizes Aν·Aν subject to the constraint that ν·ν=1. When the monthly call volume matrix, M, actually has the simple form of different weekly call volumes weighted by a single day of week distribution, then the dominant eigenvector recovers that day of week distribution, the dominant eigenvalue equals the monthly call volume, and each of the other eigenvalues are 0. When M is not of that simple form, the dominant eigenvector recovers a day of week distribution that accounts for the largest number of calls that can be attributed to a single day of week distribution and the dominant eigenvalue is that number of calls.

Example Extraction of Dominant Modes

The dominant modes of intraday distribution may be extracted, given valid intraday data for the days in a list of “comparable” dates and an intraday distribution. Some number of days of intraday data, organized by date and time-period, may be received, where the data is valid for every date and time-period. The data may be non-negative.

A maximum number may bind the number of modes (eigenvectors) that may be computed. A tolerance may be used to bind a sum of eigenvalues.

In another implementation, a list of eigenvalue, eigenvector pairs may be generated as follows, which may be a slight modification and generalization of that described in the Example Extraction Distribution above:

Let the input data comprise n days with p time-periods in each day. Let (i,j) refer to the j^{th} time-period of the i^{th} day. Let uᵢⱼ be the input data for the j^{th} time-period of the i^{th} day. For each day, i, let mᵢⱼ denote the distribution for that day. That is, let

$${m}_{ij} = \frac{{u}_{ij}}{{\sum }_{j = 1}^{p} {u}_{ij}}$$

so that

$${\sum }_{j = 1}^{p} {m}_{ij} = 1.$$

Let the intraday distribution matrix, M, be the n by p matrix with elements mᵢⱼ. As in the Example Extraction Distribution, define aᵢⱼ by the rule aᵢⱼ=\sqrt{mᵢⱼ} and let the intraday amplitude matrix, A, be the n by p matrix with elements aᵢⱼ. The analysis may now proceed as in the Example Extraction Distribution with the results: (1) A^{T} A has p non-negative eigenvalues that the can be ordered by decreasing magnitude, λ₁,λ₂, . . . ,λₚ, (2) there is a corresponding set of p orthonormal eigenvectors, {ν₁,ν₂, . . . ,νₚ} and (3) A^{T} Aνᵢ=λᵢνᵢ. Each eigenvector in the set corresponds to a different (and independent) intraday distribution or mode of distribution. The associated eigenvalue may measure the prevalence of that mode in the intraday distribution matrix, M. In particular,

$${\sum }_{ij} {m}_{ij} = {\sum }_{k} {λ}_{k} = n .$$

The modes with the largest eigenvalues may be called the dominant modes.

The parameters of the extraction dominant modes may limit the number of dominant modes that may be extracted from the intraday distribution matrix and that may be returned in the output. The described algorithm for extracting the dominant modes is an extension of the power method, which can extract eigenvalue, eigenvector pairs from A^{T} A, one pair at a time, in order of decreasing magnitude of eigenvalue. Let q be the number of pairs that have been extracted at some step of the algorithm. The extraction of pairs may cease under any of four conditions:
(1) q reaches the maximum specified in the parameters,
(2)

$$1 - \frac{{\sum }_{i = 1}^{q} {λ}_{i}}{n}$$

is less than the tolerance specified in the parameters,
(3) λ_{q}=0, or
(4) a complete set of p eigenvectors is found.

Again, the output is the ordered list of the extracted eigenvalue, eigenvector pairs. In the extended power method, the first eigenvalue, eigenvector pair is obtained from a sequence of vectors z₁,z₂, . . . ,zₙ, . . . defined by the recursion:

$${z}_{n + 1} = {A}^{T} A ( \frac{{z}_{n}}{‖ {z}_{n} ‖} ) ,$$

as described in the Example Extraction Distribution.

q eigenvalue, eigenvalue pairs {(λ₁,ν₁),(λ₂,ν₂), . . . , (λ_{q},ν_{q})} are found, where νᵢ·νᵢ=1 for i=1, . . . , q. The q+1 eigenvalue, eigenvector pair may be obtained from another sequence of vectors z₁,z₂, . . . ,zₙ, . . . , defined by the recursion:

$${z}_{n + 1} = {A}^{T} A ( \frac{{z}_{n} - ( ( {z}_{n} \cdot {v}_{1} ) {v}_{1} + ( {z}_{n} \cdot {v}_{2} ) {v}_{2} + … + ( {z}_{n} \cdot {v}_{q} ) {v}_{q} )}{‖ {z}_{n} - ( ( {z}_{n} \cdot {v}_{1} ) {v}_{1} + ( {z}_{n} \cdot {v}_{2} ) {v}_{2} + … + ( {z}_{n} \cdot {v}_{q} ) {v}_{q} ) ‖} ) .$$

For large n, ν_{q+1} is approximated by

$$\frac{{z}_{n} - ( ( {z}_{n} \cdot {v}_{1} ) {v}_{1} + ( {z}_{n} \cdot {v}_{2} ) {v}_{2} + … + ( {z}_{n} \cdot {v}_{q} ) {v}_{q} )}{‖ {z}_{n} - ( ( {z}_{n} \cdot {v}_{1} ) {v}_{1} + ( {z}_{n} \cdot {v}_{2} ) {v}_{2} + … + ( {z}_{n} \cdot {v}_{q} ) {v}_{q} ) ‖} ;$$

and λ_{q+1} is approximated by ∥zₙ₊₁∥.
Example Theory

A “month” (e.g., a block of 7-day weeks) of daily call volume data may be expressed as a product of week and day-of-week factors. That is, let mᵢⱼ denote the volume of calls on the j^{th} day of the i^{th} week and
mᵢⱼ=wⱼdⱼ, (1.1)
where wᵢ and dⱼ are not negative and some dⱼ is not 0.

M is the matrix formed from the mᵢⱼ so that
M=wd^{T}, (1.2)
where

$$\begin{matrix}w = ( \begin{matrix}{w}_{1} \\ {w}_{2} \\ {w}_{3} \\ ⋮ \\ {w}_{n}\end{matrix} ) , & ( 1.3 ) \\ d = ( \begin{matrix}{d}_{1} \\ {d}_{2} \\ {d}_{3} \\ ⋮ \\ {d}_{7}\end{matrix} ) , & ( 1.4 )\end{matrix}$$

and n is the number of weeks in the month.

Without loss of generality, it may be assumed that:

$${\sum }_{j} {d}_{j} = 1 \qquad ( 1.5 )$$

For suppose that

$${\sum }_{j} {d}_{j} = D \neq 0 ,$$

then

$$M = w {d}^{T} = ( \frac{D}{D} ) w {d}^{T} = D {w ( \frac{1}{D} d )}^{T} = \hat{w} {\hat{d}}^{T} \qquad ( 1.6 )$$

where ŵ=Dw, \hat{d}=1/D d , and

$${\sum }_{j} {\hat{d}}_{j} = 1.$$

Define the n×7 matrix, A={aᵢⱼ}, by the rule
aᵢⱼ=\sqrt{mᵢⱼ} (1.7)
and let \tilde{w}ᵢ=\sqrt{wᵢ} and \sqrt{d}ⱼ=\sqrt{dⱼ} so that
A=\tilde{w}\tilde{d}^{T} (1.8)

Again, the matrix, A, may be called the “amplitude” of the monthly call volume. Interpret A as a matrix that maps R⁷ into Rⁿ, so that for any x in R⁷, Ax is in Rⁿ.

Let (x,y) denote the usual inner product that equips either R⁷ or Rⁿ with its usual Euclidean norm, denoted ∥*∥.

In particular, note that

$$( \tilde{d} , \tilde{d} ) = {‖ \tilde{d} ‖}^{2} = {\sum }_{j} {\tilde{d}}_{j}^{2} = {\sum }_{j} {d}_{j} = 1$$

so
∥\tilde{d}∥=1 (1.9)
The following is a significant property of \tilde{d} stated as a theorem, theorem I.

Theorem I: Suppose A=\tilde{w}\tilde{d}^{T} where ∥\tilde{d}∥=1. For each x in R⁷ such that ∥x∥=1, ∥Ax∥ is a maximum when x=\tilde{d}.

Proof I:
∥Ax∥=∥\tilde{w}\tilde{d}^{T}x∥=∥\tilde{w}(\tilde{d},x)∥=|(\tilde{d},x)|∥\tilde{w}∥=∥\tilde{d}∥∥x∥∥\tilde{w}∥|cos(θ)|=∥\tilde{w}∥|cos(θ)| (1.10)
where θ is the angle between x and \tilde{d}. But |cos(θ)| is a maximum when θ is an integral multiple of π, in which case x=±\tilde{d}. Therefore, ∥Ax∥ is a maximum when x=\tilde{d}.

When M=wd^{T} and

$${\sum }_{j} {d}_{j} = 1 ,$$

there are simple ways to determine the values of the dⱼ. However, when a matrix is not of the form wd^{T} for any choices of w and d, both the meaning and values of the day-of-week factors are ambiguous. In particular, if call volumes are approximated using a pattern the calls do not actually follow, then some theory of the error in the approximations may be useful in selecting “better” (e.g. sufficient) approximations. Some absolute measure that indicates when the approximations are good (e.g. sufficient) and when they are bad (e.g. insufficient) may be useful. For example, sometimes the “best” approximation is not good enough and sometimes the “worst” approximation is sufficient. Disambiguating the concept of day-of-week factors for the case of months that do not follow the simple pattern where M=wd^{T} may be attempted.

Observe that Theorem I characterizes the day of week factors as a solution to a mathematical optimization problem. This mathematical optimization problem may include solutions even when the matrix is not of the form M=wd^{T}. Solutions to a closely related, but slightly generalized, mathematical optimization problem may be used herein to define week and day-of-week factors for general months that do not necessarily follow the simple pattern. Vectors, x, may be sought such that ∥Ax∥² is stationary, subject to the constraint that ∥x∥²=1. Note, at any vector where (subject to the constraint) ∥Ax∥² has a local maximum, has a local minimum, has a saddle point, and/or is locally constant, ∥Ax∥² may be stationary. More formally, a real-valued function, F, is said to be stationary at x subject to the constraint that ∥x∥=1 whenever

$${lim}_{{y \to x}_{‖ y ‖ = 1}} \frac{F ( x ) - F ( y )}{‖ x - y ‖} = 0. \qquad ( 1.11 )$$

It turns out, when there are less than 8 weeks in a plurality of intervals or a “month”, these optimal vectors may be used to exactly express both A and M in terms of products of week and day-of-week factors. As well, they may provide simple approximations of A and M with known error.

Analysis and interpretation of these optimal vectors, x, are discussed below:

Let M be an n×7 real matrix with elements mᵢⱼ≧0 for i=1, 2, . . . , n and j=1, 2, . . . , 7. n≦7 may be assumed. Let A be the amplitude of M, so that A is an n×7 real matrix with elements aᵢⱼ>0, where aᵢⱼ=\sqrt{mᵢⱼ} for i=1,2, . . . , n and j=1,2, . . . , 7.

Vectors, x in R⁷ that make ∥Ax∥² stationary may be sought, subject to the constraint that ∥x∥=1 Using the technique of Lagrange multipliers, this mathematical problem involving a constraint may be solved upon introduction of a new, auxiliary variable, λ, used to define a related mathematical problem that does not involve any constraints. An auxiliary function H may be defined by:
H=∥Ax∥²−λ(∥x∥²−1). (1.12)

In an embodiment, from calculus, the values of x and λ for which H is stationary, give exactly the values of x for which ∥Ax∥² is stationary, subject to the constraint that ∥x∥=1. Let x be expressed in components as

$$x = ( \begin{matrix}{x}_{1} \\ {x}_{2} \\ {x}_{3} \\ ⋮ \\ {x}_{7}\end{matrix} ) . \qquad ( 1.13 )$$

A condition that H is stationary is given by the following system of 8 equations:

$$\begin{matrix}\frac{\partial H}{\partial {x}_{1}} = 0 \\ \frac{\partial H}{\partial {x}_{2}} \\ ⋮ \\ \frac{\partial H}{\partial {x}_{7}} = 0 \\ \frac{\partial H}{\partial λ} = 0.\end{matrix} \qquad ( 1.14 )$$

Expressing H in components includes:

$$\begin{matrix}\begin{matrix}H = {‖ Ax ‖}^{2} - λ ( {‖ x ‖}^{2} - 1 ) \\ = ( Ax , Ax ) - λ ( ( x , x ) - 1 ) \\ = {\sum }_{k} {( {\sum }_{i} {a}_{ki} {x}_{i} )}^{2} - λ ( {\sum }_{s} {x}_{s}^{2} - 1 ) ;\end{matrix} & ( 1.15 ) \\ so & \\ \frac{\partial H}{\partial {x}_{r}} = 2 {\sum }_{k} ( {\sum }_{i} {a}_{ki} {x}_{i} ) ( {\sum }_{i} {a}_{ki} \frac{\partial {x}_{i}}{\partial {x}_{r}} ) - 2 λ ( {\sum }_{s} {x}_{s} \frac{\partial {x}_{s}}{\partial {x}_{r}} ) ; & ( 1.16 ) \\ \frac{\partial H}{\partial {x}_{r}} = 2 {\sum }_{k} ( {\sum }_{i} {a}_{ki} {x}_{i} ) {a}_{kr} - 2 λ {x}_{r} . & ( 1.17 )\end{matrix}$$

Enforcing the first 7 conditions in (1.14), the following is determined:

$${\sum }_{i} ( {\sum }_{k} {a}_{kr} {a}_{ki} ) {x}_{i} - λ {x}_{r} = 0 ; r = 1 , 2 , … , 7 \qquad ( 1.18 )$$

or simply:
A^{T} Ax=λx (1.19)

Enforcing the last condition in (1.14) by differentiating (1.15) with respect to λ and setting the result to 0 gives:
∥x∥²=1 (1.20)

Equations (1.19) and (1.20) define a kind of eigenvector-eigenvalue mathematical problem. An eigenvector of (1.19) is any x such that x≠0 and A^{T} Ax=λx for some number, λ.

An eigenvalue of (1.19) is any number, λ, such that A^{T} Ax=λx for some x≠0. Note that when ν is an eigenvector of (1.19), so is ν/∥ν∥, and ν/∥ν∥ also satisfies equation (1.20). The “stationary” vectors for the mathematical optimization problem may be found if the eigenvectors of (1.19) may be found.

A matrix, B, is symmetric if B=B^{T}. A set of vectors, {ν₁,ν₂, . . . ,νₖ} in R^{m} is orthogonal if (νᵢ,νⱼ)=0, whenever is j and (νᵢ,νⱼ)≠0 whenever i=j. A set of vectors, {ν₁,ν₂, . . . ,νₖ} in R^{m} is orthonormal if it is orthogonal and (νᵢ, νᵢ)=1 for i=1, 2, . . . , k.

The matrix, A^{T} A, is a 7×7 real matrix and is “symmetric” in that (A^{T}A)^{T}=((A)^{T}(A^{T})^{T})=A^{T}A. In other words, the matrix equals its own transpose.

From the theory of linear algebra, it is asserted that:
(1) Each of the eigenvalues of a real, symmetric matrix are real.
(2) If λ₁ and λ₂ are distinct eigenvectors of a real, symmetric matrix, and if ν₁ is an eigenvector for λ₁ and ν₂ is an eigenvector for λ₂, then (ν₁,ν₂)=0.
(3) For any m×m real, symmetric matrix there is at least one set of m, orthonormal eigenvectors.
(4) The eigenvalues of a real, symmetric matrix, are the roots of a real polynomial of degree m. As such, any particular eigenvalue may be a root more than once. Therefore, by the Fundamental Theorem of Algebra, the number of eigenvalues, counting repetitions, is m. The number of distinct eigenvalues is between 1 and m.

Theorem II: The eigenvalues of the matrix A^{T} A are not negative.

Proof II: Let ν be an eigenvector of A^{T} A corresponding to the eigenvalue, λ. Let y be defined by the rule: y=Aν. Then:
0≦(y,y)=(Aν,Aν)=(ν, A^{T} Aν)=(ν,λν)=λ(ν,ν) (2.1)
but (ν,ν)>0 so λ≧0.

Let {ν₁,ν₂, . . . ν₇} be a set of orthonormal eigenvectors for A^{T} A. The indices may be assumed to have been arranged in order by the decreasing magnitude of the eigenvalues. That is, when A^{T} Aνᵢ=λᵢνᵢ, then λᵢ≧λⱼ whenever i<j.

Each of the first p eigenvalues in this ordering may be assumed as positive, but any other eigenvalues may be 0.

Define \tilde{y}ᵢ by the rule \tilde{y}ᵢ=Aνᵢ for i=1, 2, . . . , p . Let

$${y}_{i} = \frac{{\tilde{y}}_{i}}{‖ {\tilde{y}}_{i} ‖}$$

for i=1,2, . . . ,p.

Theorem III: ∥\tilde{y}∥=\sqrt{λᵢ}, for i=1,2, . . . , p.

Proof III: ∥yᵢ∥²=(\tilde{y}ᵢ,\tilde{y}ᵢ)=(Aνᵢ,Aνᵢ)=λᵢ(νᵢ,νᵢ)=λᵢ.

Theorem IV: {y₁,y₂, . . . yₚ} is orthonormal.

Proof IV:

$$( {y}_{i} , {y}_{i} ) = ( \frac{{\tilde{y}}_{i}}{‖ {\tilde{y}}_{i} ‖} , \frac{{\tilde{y}}_{i}}{‖ {\tilde{y}}_{i} ‖} ) = \frac{1}{{‖ {\tilde{y}}_{i} ‖}^{2}} ( {\tilde{y}}_{i} , {\tilde{y}}_{i} ) = \frac{{‖ {\tilde{y}}_{i} ‖}^{2}}{{‖ {\tilde{y}}_{i} ‖}^{2}} = 1 ,$$

so the yᵢ is normalized.

On the other hand,

$$\begin{matrix}( {y}_{i} , {y}_{j} ) = ( \frac{1}{\sqrt{{λ}_{i}}} A {v}_{i} , \frac{1}{\sqrt{{λ}_{j}}} A {v}_{j} ) \\ = \frac{1}{\sqrt{{λ}_{i} {λ}_{j}}} ( {v}_{i} , {A}^{T} A {v}_{j} ) \\ = \frac{\sqrt{{λ}_{j}}}{\sqrt{{λ}_{i}}} ( {v}_{i} , {v}_{j} )\end{matrix} \qquad ( 2.2 )$$

But since {ν₁,ν₂, . . . ν₇} is orthonormal so is {ν₁,ν₂, . . . νₚ}. Therefore, (νᵢ,νⱼ)=0 and the equality (2.2) forces (yᵢ,yⱼ)=0 whenever i≠j. But then the elements of {y₁,y₂, . . . yₚ} are both normal and orthogonal. Therefore, {y₁,y₂, . . . yₚ} is orthonormal.

Theorem V: The amplitude, A, of a month, M, decomposes into a sum of matrices each of which is the product of week and day-of-week factors and where both the set of week factors and the set of day-of-week factors are orthonormal. That is,

$$A = {\sum }_{i = 1}^{p} \sqrt{{λ}_{i}} {y}_{i} {v}_{i}^{T} \qquad ( 2.3 )$$

where {y₁,y₂, . . . yₚ} and {ν₁,ν₂, . . . νₚ} are both orthonormal.

Proof V: Let

$$\overline{A} = {\sum }_{i = 1}^{p} \sqrt{{λ}_{i}} {y}_{i} {v}_{i}^{T}$$

and let x be any vector in R⁷ . Let cᵢ=(x,νᵢ) for i=1,2, . . . ,7. But then

$$x = {\sum }_{i = 1}^{7} {c}_{i} {v}_{i}$$

because {ν₁,ν₂, . . . ν₇} spans R⁷ and

$$( x - {\sum }_{i = 1}^{7} {c}_{i} {v}_{i} , {v}_{j} ) = 0 ,$$

for each j=1,2, . . . ,7. Therefore,

$$\begin{matrix}\overline{A} x = \overline{A} {\sum }_{i = 1}^{7} {c}_{i} {v}_{i} \\ = {\sum }_{i = 1}^{p} \sqrt{{λ}_{i}} {y}_{i} {v}_{i}^{T} {\sum }_{r = 1}^{7} {c}_{r} {v}_{r} \\ = {\sum }_{i = 1}^{p} {\sum }_{r = 1}^{7} \sqrt{{λ}_{i}} {c}_{r} {y}_{i} {v}_{i}^{T} {v}_{r} \\ = {\sum }_{i = 1}^{p} {\sum }_{r = 1}^{7} \sqrt{{λ}_{i}} {c}_{r} {y}_{i} ( {v}_{i} , {v}_{r} ) \\ = {\sum }_{i = 1}^{p} \sqrt{{λ}_{i}} {c}_{i} {y}_{i} \\ = {\sum }_{i = 1}^{p} {c}_{i} \sqrt{{λ}_{i}} {y}_{i} \\ = {\sum }_{i = 1}^{p} {c}_{i} {\tilde{y}}_{i} \\ = {\sum }_{i = 1}^{p} {c}_{i} A {v}_{i} \\ = {\sum }_{i = 1}^{7} {c}_{i} A {v}_{i} \\ = A {\sum }_{i = 1}^{7} {c}_{i} {v}_{i} \\ = A x\end{matrix} \qquad ( 2.4 )$$

In an embodiment, because x is arbitrary, A̅x=Ax for each x in R⁷. Therefore, A̅=A. Therefore

$$A = {\sum }_{i = 1}^{p} \sqrt{{λ}_{i}} {y}_{i} {v}_{i}^{T} .$$

Define Aₖ by the rule Aₖ=yₖνₖ^{T} and αₖ by the rule αₖ=\sqrt{λₖ} for k=1, 2, . . . , p. Then A may be expressed as:

$$A = {\sum }_{k = 1}^{p} {α}_{k} {A}_{k} \qquad ( 2.5 )$$

This shows that A is a weighted sum of “simple” amplitudes, the Aₖ, each of the forms given in (1.8). Each such amplitude is an n×7 matrix. Let a_{k;ij} denote the coefficient in the i^{th} row and j^{th} column of Aₖ. For each k let y_{k;i} denote the i^{th} component of yₖ and let ν_{k;j} denote the j^{th} component of νₖ. Therefore, a_{k;ij}=y_{k;i}ν_{k;j}. The coefficients of any amplitude may also be considered to be a vector in R⁷ⁿ, with its usual norm and inner product. In this case, ∥Aₖ∥² may be defined as

$${\sum }_{i = 1}^{n} {\sum }_{j = 1}^{7} {a}_{k ; ij}^{2}$$

and (Aₖ,A_{q}) may be defined as

$${\sum }_{i = 1}^{n} {\sum }_{j = 1}^{7} {a}_{k ; ij} {a}_{q ; ij} .$$

For each k, define a corresponding call-volume matrix, Mₖ, by the rule m_{k;ij}=λₖa_{k;ij}².

The amplitudes, Aₖ, may enjoy a number of significant properties. For example see Theorem VI.

Theorem VI:
Aₖ^{T}Aᵣ=0 and AₖAᵣ^{T}=0 when k≠r.
Aₖ^{T}Aₖ=νₖνₖ^{T}= and AₖAₖ^{T}=yₖyₖ^{T}.
(Aₖ,Aₖ)=∥Aₖ∥²=1.
(Aₖ,A_{q})=0 when k≠q.

There are also significant properties of M expressed in terms of the eigenvalues as shown in Theorem VII.

Theorem VII:

$${\sum }_{i = 1}^{n} {\sum }_{j = 1}^{7} {m}_{ij} = {\sum }_{k = 1}^{p} {λ}_{k}$$

$${\sum }_{i = 1}^{n} {\sum }_{j = 1}^{7} {m}_{k ; ij} = {λ}_{k}$$

In other words, the total monthly call volume equals the sum of the call volumes due to each of the k patterns.

A call may be assumed to have a state indexed by k. Each amplitude matrix, Aₖ, may be an amplitude describing the week˜day-of-week distribution of a call that is in the k^{th} state. When a call is in the k^{th} state, the probability, P_{k;ij}, that the call may arrive on the j^{th} day of the i^{th} week may be defined to be a_{k;ij}²=y_{k;i}²ν_{k;j}². That is, p_{k;ij} may be defined by the rule p_{k;ij}=a_{k;ij}². Note that the probability that a call in the k^{th} state arrives on some day is

$${\sum }_{i} {\sum }_{j} {p}_{k ; ij} = 1 ,$$

that it arrives on the j^{th} day of some week is

$${\sum }_{i} {p}_{k ; ij} = {v}_{k ; j}^{2} ,$$

and that it arrives on some day during the i^{th} week is

$${\sum }_{j} {p}_{k ; ij} = {y}_{k ; i}^{2} .$$

Therefore, when in the k^{th} state, the weekday-of-week joint probability distribution is the product of two independent probability distributions, one for the week and one for the day-of-week.

In an implementation, a call may be in a blend (or superposition) of states. The blend may be described by defining amplitudes, βₖ, for the call to be, in each of the k states. In an implementation,

$${\sum }_{k} {β}_{k}^{2} = 1 ,$$

so that βₖ² is the probability that the call may be in the k^{th} state. The amplitude for the week-day-of-week distribution of the blended call is

$${\sum }_{k} {β}_{k} {A}_{k} .$$

The probability that the blended call may arrive on the j^{th} day of the i^{th} week is

$${( {\sum }_{k} {β}_{k} {a}_{k ; ij} )}^{2} .$$

In this formulation, the probability for a given day of the month is the result of interference of the weighted amplitudes of each of the states on that day. It may be shown that

$${\sum }_{i} {( {\sum }_{k} {β}_{k} {a}_{k ; ij} )}^{2} = {\sum }_{k} {β}_{k}^{2} {v}_{k ; j}^{2}$$

and similarly,

$${\sum }_{j} {( {\sum }_{k} {β}_{k} {a}_{k ; ij} )}^{2} = {\sum }_{k} {β}_{k}^{2} {y}_{k ; i}^{2} .$$

The former asserts that the probability a blended call arrives on the j^{th} day of some week is just the sum, over all states, of the probability the call is in the k^{th} state times the probability the call arrives on the j^{th} day of some week given the call is in the k^{th} state. The latter asserts that the probability a blended call arrives on some day during the i^{th} week is just the sum, over all states, of the probability the call is in the k^{th} state times the probability the call arrives on some day during the i^{th} week given the call is in the k^{th} state. In other words, ν_{k;j}² is the conditional probability that a call arrives on the j^{th} day of the week, given the call is in state k, and y_{k;i}² is the conditional probability that a call arrives on i^{th} week, given the call is in state k.

The probability amplitude, γₖ, may be defined by the rule:

$${γ}_{k} = \frac{{α}_{k}}{{\sum }_{k} {α}_{k}^{2}} \qquad ( 2.6 )$$

so that

$${\sum }_{k} {γ}_{k}^{2} = 1.$$

N may be defined to be the total number of calls in the month. That is,

$$N = {\sum }_{i} {\sum }_{j} {m}_{ij} \qquad ( 2.7 )$$

In this case, M may be interpreted as giving the expected number of calls on each day of the month when N calls arrive that month and each call has a probability amplitude given by:

$${\sum }_{k} {γ}_{k} {A}_{k} \qquad ( 2.8 )$$

Furthermore,

$$A = \sqrt{N} {\sum }_{k = 1}^{p} {γ}_{k} {A}_{k} \qquad ( 2.9 )$$

Finally, this analysis suggests two alternate ways to think about the day-of-week distribution for a month:
(1) Each call of the month may be substantially identically distributed and each call has an amplitude, γₖ, to be in the k^{th} state.
(2) There are p different kinds of calls during the month. For each kind, indexed by k=1, 2, . . . ,p, there is a probability distribution for the day of week of its arrival given by ν_{k;j}². The different kinds of calls may be statistically independent. The probability that a call is of the k^{th} kind is γₖ².

The second alternative above may suggest the following: any given call is most likely of the kind where k=1. This is because the eigenvalues discussed above are ordered in such a way that γ₁≧γₖ. for each k, γₖ² is greatest when k=1. Therefore, k=1 is a most probable kind of call; when the largest eigenvalue is unique, k=1 is the most probable kind of call. Therefore, for any given call, a most likely day-of-week probability distribution is given by ν_{1;j}².

Averaging over each calls, the expected value of the day-of-week probability distribution may be

$${\sum }_{k} {γ}_{k}^{2} {v}_{k ; j}^{2} .$$

Example Implementation

In an example embodiment, there are seven weeks of a calendar is considered a kind of “long” month and there is a “count” of events or contacts associated with each day of the seven week period, as shown in Matrix 1, where M denotes the matrix 1 formed from elements mᵢⱼ. It is assumed that mᵢⱼ≧0 for each i and j. Elements mᵢⱼ correspond to the number of contacts (e.g., call counts) during the particular period i of j. Seven weeks is chosen in this example, however, any number of weeks may be used. Further, i is chosen in this example to correspond to a day, however, any time period may be used. In addition, j is chosen in this example to correspond to a week, however, any time period may be used.

MATRIX 1, M:

| | | | | | | |
|---|---|---|---|---|---|---|
| 18 | 47 | 48 | 11 | 43 | 59 | 26 |
| 19 | 43 | 31 | 22 | 33 | 64 | 39 |
| 24 | 44 | 35 | 19 | 32 | 43 | 25 |
| 31 | 22 | 31 | 44 | 35 | 37 | 37 |
| 41 | 36 | 33 | 36 | 35 | 27 | 45 |
| 47 | 25 | 34 | 57 | 28 | 15 | 36 |
| 46 | 15 | 29 | 57 | 19 | 11 | 51 |

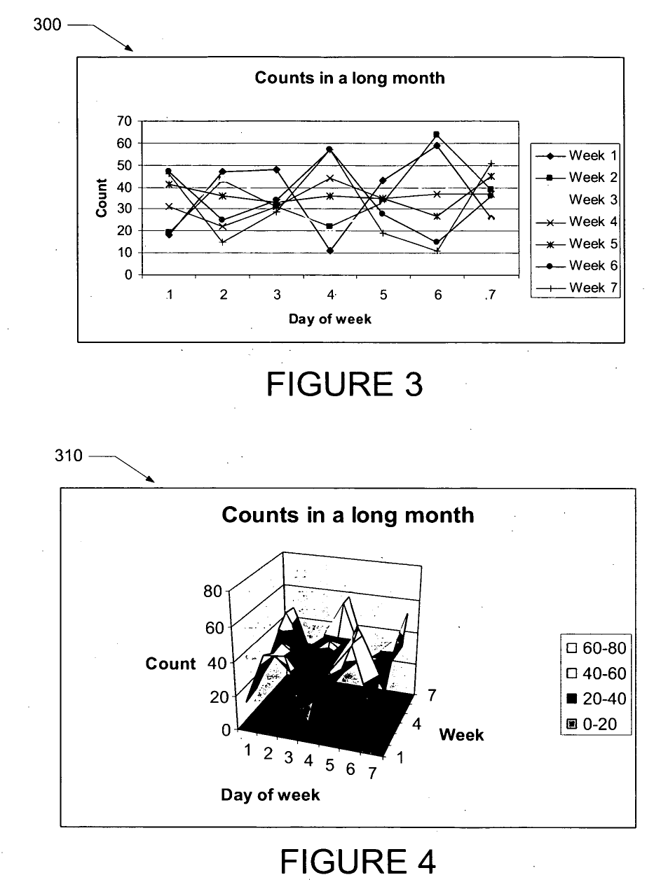

Each column corresponds to a day of the week and each row corresponds to a week of the long month. The counts in Matrix 1 were generated by a stochastic process. This matrix (table) of counts might also be visualized graphically as either a sequence of weeks as shown in FIG. 3, or as a surface over a day-of-week vs. week plane, as shown in FIG. 4.

The amplitude A of the counts of the month is obtained by taking the square root of the counts mᵢⱼ on each day, as shown in Matrix 2, A. A denotes the matrix formed from the elements aᵢⱼ. aᵢⱼ is defined by the rule aᵢⱼ=\sqrt{mᵢⱼ}.

MATRIX 2, A:

| | | | | | | |
|---|---|---|---|---|---|---|
| 4.242641 | 6.855655 | 6.928203 | 3.316625 | 6.557439 | 7.681146 | 5.09902 |
| 4.358899 | 6.557439 | 5.567764 | 4.690416 | 5.744563 | 8 | 6.244998 |
| 4.898979 | 6.63325 | 5.91608 | 4.358899 | 5.656854 | 6.557439 | 5 |
| 5.567764 | 4.690416 | 5.567764 | 6.63325 | 5.91608 | 6.082763 | 6.082763 |
| 6.403124 | 6 | 5.744563 | 6 | 5.91608 | 5.196152 | 6.708204 |
| 6.855655 | 5 | 5.830952 | 7.549834 | 5.291503 | 3.872983 | 6 |
| 6.78233 | 3.872983 | 5.385165 | 7.549834 | 4.358899 | 3.316625 | 7.141428 |

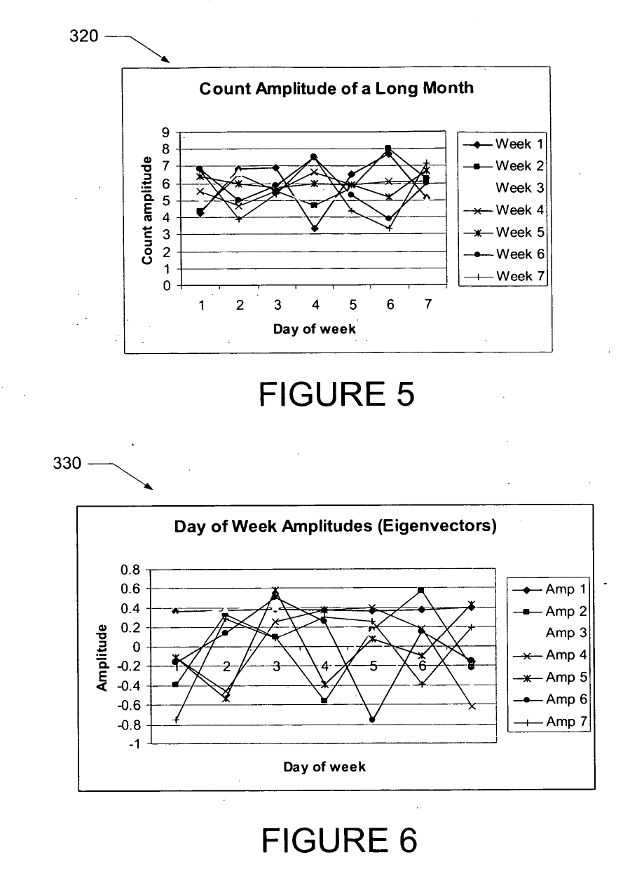

The graph associated with the amplitude of the counts of the month is illustrated at FIG. 5.

This amplitude matrix (Matrix 2, A) is multiplied (using matrix multiplication) on the left by its own transpose to obtain a symmetric day-of-week by day-of week matrix, which can be thought of as the “inner-square” of the count amplitude matrix as shown in Matrix 3. Let A^{T} be the transpose of A.

MATRIX 3, A^{T} A:

| | | | | | | |
|---|---|---|---|---|---|---|
| 226 | 215.2454 | 226.9281 | 234.1861 | 217.2346 | 215.7696 | 239.7398 |
| 215.2454 | 232 | 233.8444 | 216.5107 | 226.7333 | 240.5337 | 235.5131 |
| 226.9281 | 233.8444 | 241 | 230.9605 | 232.1346 | 240.7137 | 245.5247 |
| 234.1861 | 216.5107 | 230.9605 | 246 | 220.9489 | 217.3878 | 247.811 |
| 217.2346 | 226.7333 | 232.1346 | 220.9489 | 225 | 235.0973 | 236.1457 |
| 215.7696 | 240.5337 | 240.7137 | 217.3878 | 235.0973 | 256 | 240.6937 |
| 239.7398 | 235.5131 | 245.5247 | 247.811 | 236.1457 | 240.6937 | 259 |

The eigenvalues λ and a set of orthonormal eigenvectors ν for the inner-square of the amplitude can be found by any method known to those of skill in the art, solving the mathematical eigenvalue-eigenvector problem:
A^{T} Aνᵢ=λᵢνᵢ.

Matrix 4 illustrates the eigenvalues λ₁ of the inner-square of the count amplitude in this example.

MATRIX 4, λᵢ:

1627.355 51.22686 3.521141 1.6047 0.874811 0.395056 0.022026

In this example, each of the eigenvalues λ₁ are non-negative and the sum of the eigenvalues λ₁ is 1685. The sum of the eigenvalues λ₁ equals the total number of counts mᵢⱼ in the long month, in this example.

Matrix 5 illustrates the eigenvectors νᵢⱼ.

MATRIX 5, vᵢⱼ:

| | | | | | | |
|---|---|---|---|---|---|---|
| 0.365907 | 0.371828 | 0.383599 | 0.374898 | 0.370173 | 0.382516 | 0.395996 |
| −0.38769 | 0.338691 | 0.091681 | −0.56956 | 0.167401 | 0.571536 | −0.21795 |
| 0.321533 | 0.392462 | 0.412598 | −0.2747 | 0.149128 | −0.55417 | −0.40933 |
| −0.11079 | −0.4557 | 0.253181 | 0.37785 | 0.399282 | 0.178181 | −0.61808 |
| −0.11043 | −0.53142 | 0.588301 | −0.39398 | 0.07867 | −0.1052 | 0.432223 |
| −0.16498 | 0.135608 | 0.507372 | 0.262446 | −0.76273 | 0.153889 | −0.1505 |
| −0.74882 | 0.290771 | 0.081137 | 0.3045 | 0.255614 | −0.39169 | 0.19144 |

In Matrix 5 of eigenvectors, each row gives the components of an eigenvector. The first row is an eigenvector for the first eigenvalue, the second row is an eigenvector for the second eigenvalue, and so on. These particular eigenvectors form an orthonormal set.

Each eigenvector ν describes a pattern of distribution of counts across the days of the week. The corresponding eigenvalue gives the count of events or contacts that follow that pattern. FIG. 6 illustrates a graph of the eigenvectors νᵢⱼ.

The sum of the squares of the components of each eigenvector equals one (1). Therefore, the squares of the components of each eigenvector may be interpreted as a probability distribution. In this situation, each eigenvector may be thought of as the “amplitude” of a day-of-week probability distribution. Matrix 6 illustrates the probability distributions obtained from their amplitudes by squaring components as follows: νᵢⱼ².

MATRIX 6:

| | | | | | | |
|---|---|---|---|---|---|---|
| 0.133888 | 0.138256 | 0.147148 | 0.140548 | 0.137028 | 0.146318 | 0.156813 |
| 0.150305 | 0.114712 | 0.008405 | 0.324401 | 0.028023 | 0.326654 | 0.047501 |
| 0.103383 | 0.154027 | 0.170237 | 0.075459 | 0.022239 | 0.307106 | 0.167549 |
| 0.012274 | 0.207659 | 0.064101 | 0.14277 | 0.159426 | 0.031748 | 0.382021 |
| 0.012196 | 0.282409 | 0.346098 | 0.155223 | 0.006189 | 0.011068 | 0.186817 |
| 0.027218 | 0.01839 | 0.257427 | 0.068878 | 0.581756 | 0.023682 | 0.02265 |
| 0.560736 | 0.084548 | 0.006583 | 0.09272 | 0.065339 | 0.153424 | 0.036649 |

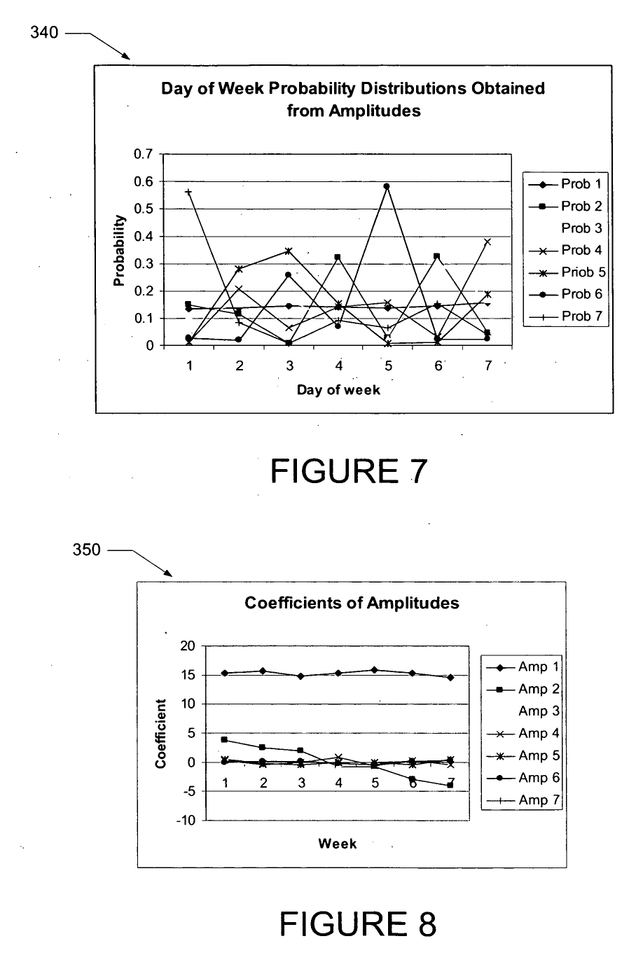

FIG. 7 illustrates the graph associated with Matrix 6. FIG. 7 illustrates an estimate of a probability distribution of arrival of a contact call for each day of the week, wherein the contact call is to arrive during the week.

The components of the dominant day of week distribution, dⱼ, are given by dⱼ=(νᵢⱼ)² for j=1,2, . . . , 7.

The count amplitude of any week in the long month may be expressed as a linear combination of the day-of-week amplitudes. Matrix 7 illustrates coefficients that can be used to express each week of the count amplitude of the long month as a linear combination of the day-of-week amplitudes. In one of many possible implementations, Matrix 7 may be calculated by the dot product of Matrix 2 and Matrix 5: aᵢⱼ·νᵢⱼ. In Matrix 7, the columns correspond to the different weeks of the month and the rows correspond to the different day-of-week amplitudes.

MATRIX 7, aᵢⱼ · vᵢⱼ:

| | | | | | | |
|---|---|---|---|---|---|---|
| 15.38732 | 15.58701 | 14.74486 | 15.32937 | 15.86092 | 15.25106 | 14.52813 |
| 3.799734 | 2.54287 | 2.012101 | −0.6964 | −0.84288 | −2.93826 | −4.05528 |
| 0.636287 | −1.14907 | 0.58508 | −0.87234 | 0.392439 | 0.685395 | −0.2624 |
| 0.248452 | −0.42994 | −0.08395 | 0.848169 | −0.58021 | 0.385405 | −0.38276 |
| 0.569094 | −0.22904 | −0.3867 | 0.009266 | −0.06182 | −0.35619 | 0.467084 |
| 0.028447 | 0.135728 | 0.1789 | −0.20845 | −0.47574 | 0.14392 | 0.230928 |
| 0.032158 | 0.053037 | −0.09775 | −0.03972 | 0.004068 | 0.076414 | −0.0345 |

That is to say, for example, the count amplitude of the first week of the long month equals 15.38732 times the first eigenvector plus 3.799734 times the second eigenvector . . . plus 0.032158 times the seventh eigenvector.

FIG. 8 illustrates a graph of the coefficients associated with Matrix 7. This graph shows that the first amplitude (eigenvector) contributes with a weight of about 15 to each week of the count amplitude, that the second amplitude contributes with a weight that is roughly linearly decreasing from about 4 to -4 across the weeks of the month, and that the other amplitudes do not make much of a contribution to the count amplitude of any week. These observations are in line with the values of the corresponding eigenvalues. The first two eigenvalues (from Matrix 4) account for the distribution of 1627.355+51.22686=1678.582 out of a total of 1685 counts during the month. In that sense, the distribution of counts, in this particular example of a long month is dominated by just two day-of-week patterns: those that are given by the first two day-of-week amplitudes. Therefore, the distribution of counts on any week of the month may be approximated using just those two day-of-week amplitudes.

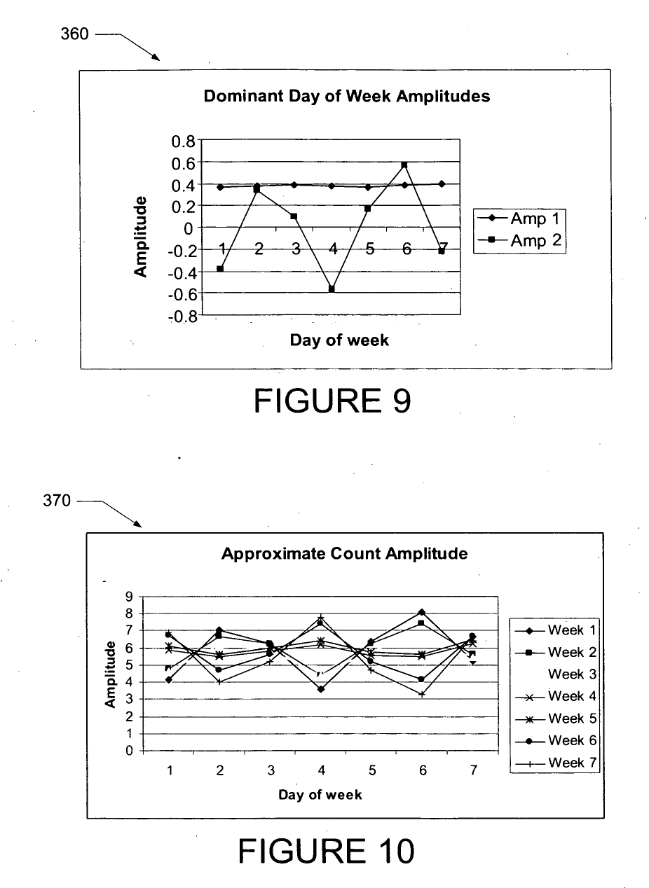

Matrix 8 includes a table of the two dominant day-of-week amplitude's coefficients in the count amplitude of the month. Matrix 8 is the same as the first two rows of Matrix 7. FIG. 9 illustrates a graph of the two dominant day-of-week amplitudes of Matrix 8.

MATRIX 8

| | | | | | | |
|---|---|---|---|---|---|---|
| 15.38732 | 15.58701 | 14.74486 | 15.32937 | 15.86092 | 15.25106 | 14.52813 |
| 3.799734 | 2.54287 | 2.012101 | −0.6964 | −0.84288 | −2.93826 | −4.05528 |

The count distribution may be approximated from the dominant day-of-week amplitudes. First, the count amplitude of the first week may be approximated as 15.38732*Amp1+3.799743*Amp2, and the count amplitude of the second week may be approximated as 15.58701*Amp1+2.54287*Amp2, and so on, to approximate the count amplitude of the seventh week as 14.52813*Amp1+−4.05528*Amp2.

Matrix 9 and FIG. 10 illustrate the approximate count amplitude of the long month. To recover an approximation of the raw count data, the results of Matrix 9 is calculated. Matrix 9, Pᵢⱼ, may be calculated by multiplying the coefficients matrix (Matrix 7) by the Amplitude Matrix (Matrix 2) and summing: Pᵢⱼ=Σ[(aᵢⱼ·νᵢⱼ)×(aᵢⱼ)].

MATRIX 9, Pᵢⱼ

| | | | | | | |
|---|---|---|---|---|---|---|
| 4.1572 | 7.008375 | 6.250927 | 3.604489 | 6.332055 | 8.057578 | 5.265181907 |
| 4.717542 | 6.656937 | 6.212297 | 4.395213 | 6.195574 | 7.415619 | 5.61818689 |
| 4.61517 | 6.164035 | 5.840588 | 4.3818 | 5.794982 | 6.79013 | 5.400379096 |
| 5.879108 | 5.464025 | 5.816485 | 6.143591 | 5.557944 | 5.465704 | 6.222151165 |
| 6.130393 | 5.61206 | 6.006957 | 6.426296 | 5.730189 | 5.585314 | 6.464566996 |
| 6.719605 | 4.675611 | 5.58091 | 7.391112 | 5.153667 | 4.154448 | 6.679748137 |
| 6.88814 | 4.02848 | 5.201185 | 7.756301 | 4.699067 | 3.239497 | 6.636922234 |

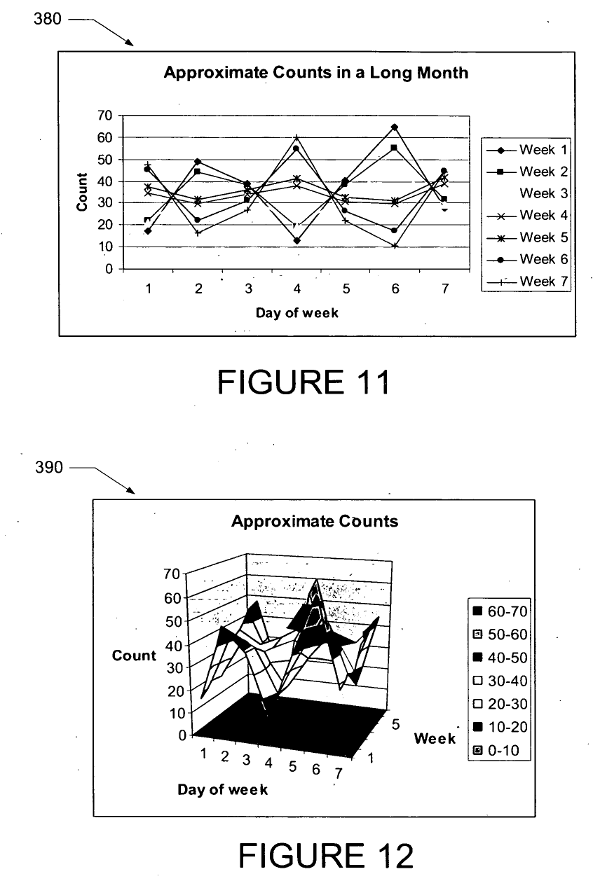

The component of the count amplitude on any day of the month may be squared to obtain the approximate number of counts for that day. Matrix 10 and FIGS. 11 and 12 illustrate the approximate count distribution. Matrix 10 is calculating by squaring Matrix 9.

MATRIX 10, Pᵢⱼ ²

| | | | | | | |
|---|---|---|---|---|---|---|
| 17.28231 | 49.11732 | 39.07409 | 12.99234 | 40.09492 | 64.92457 | 27.72214051 |
| 22.25521 | 44.3148 | 38.59263 | 19.3179 | 38.38513 | 54.99141 | 31.56402393 |
| 21.29979 | 37.99533 | 34.11247 | 19.20017 | 33.58181 | 46.10587 | 29.16409438 |
| 34.56391 | 29.85557 | 33.83149 | 37.74372 | 30.89074 | 29.87392 | 38.71516512 |
| 37.58172 | 31.49522 | 36.08354 | 41.29728 | 32.83506 | 31.19573 | 41.79062645 |
| 45.15309 | 21.86134 | 31.14655 | 54.62854 | 26.56028 | 17.25943 | 44.61903517 |
| 47.44647 | 16.22865 | 27.05232 | 60.1602 | 22.08123 | 10.49434 | 44.04873673 |

The total number of counts in this approximation is 1678.582 and that is just the sum of the first two eigenvalues. When two or more amplitudes are used in such an approximation, the act of squaring that converts a count amplitude to a count, results in “interaction” or “interference” among the amplitudes.

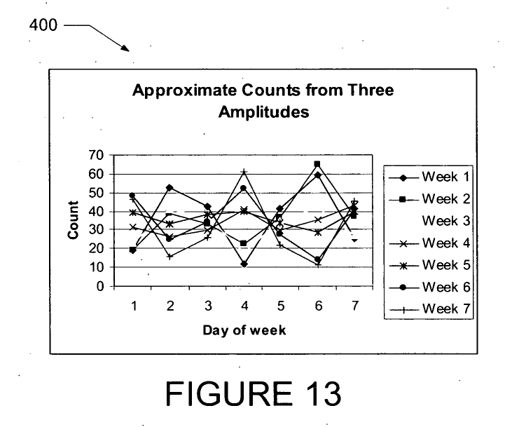

If the first three amplitudes are used, then a better approximation of actual counts may be obtained in this instance, as compared to using the first two amplitudes. Matrix 1 1 and FIG. 13 illustrate the count approximation (calculated in a manner similar to Matrix 10) in the case of three amplitudes.

MATRIX 11

| | | | | | | |
|---|---|---|---|---|---|---|
| 19.02519 | 52.67993 | 42.42514 | 11.76286 | 41.3056 | 59.3665 | 25.04734 |
| 18.9058 | 38.51408 | 32.92687 | 22.1922 | 36.29118 | 64.84111 | 37.07021 |
| 23.07162 | 40.87885 | 36.99061 | 17.81752 | 34.60067 | 41.80781 | 26.63478 |
| 31.34457 | 26.23144 | 29.77403 | 40.74552 | 29.46159 | 35.39216 | 43.28619 |
| 39.14474 | 33.24765 | 38.05504 | 39.92336 | 33.50919 | 28.81366 | 39.73955 |
| 48.16334 | 24.4491 | 34.38301 | 51.88084 | 27.62426 | 14.24777 | 40.94972 |
| 46.29128 | 15.40953 | 25.93782 | 61.28356 | 21.715 | 11.45763 | 45.48599 |

Matrix 11 and FIG. 13 are count approximation in the case of three amplitudes for the actual counts of FIGS. 3 and 4.

One use of the automated algorithms described herein is to update the probability distributions used in a model to forecast future counts. These automated algorithms may make consistent judgments about enormous quantities of numerical data, and may reduce the risk that clerical errors associated with manual update activities may deform the forecast model. Automated introduction of the new data may avoid inappropriate changes in the day of week patterns that are extracted from the data, which may reduce deformation of the forecast model.

Output for this method includes a day of week distribution, in an embodiment. In the case of call-volume, the output is a single (conditional) probability distribution used to describe the probability that a call arrives on a particular day of the week, given that the call arrives sometime that week.

There may be multiple day of week distributions, one corresponding to each week. In an additional embodiment, the extraction of this distribution may take into account that a single day-of-week distribution may be used to represent each week of the month, even though the data may follow different distributions for each week. In some embodiments, an accurate representative distribution may not be a simple average of the day of week data or the distribution for any particular week of the month. Rather, it may depend on co-variation (or correlation) in the data due to the week of the month and the day of the week interactions. For this reason, a kind of singular value decomposition may be used to extract a dominant day-of-week distribution for a month of data.

Computer Architecture

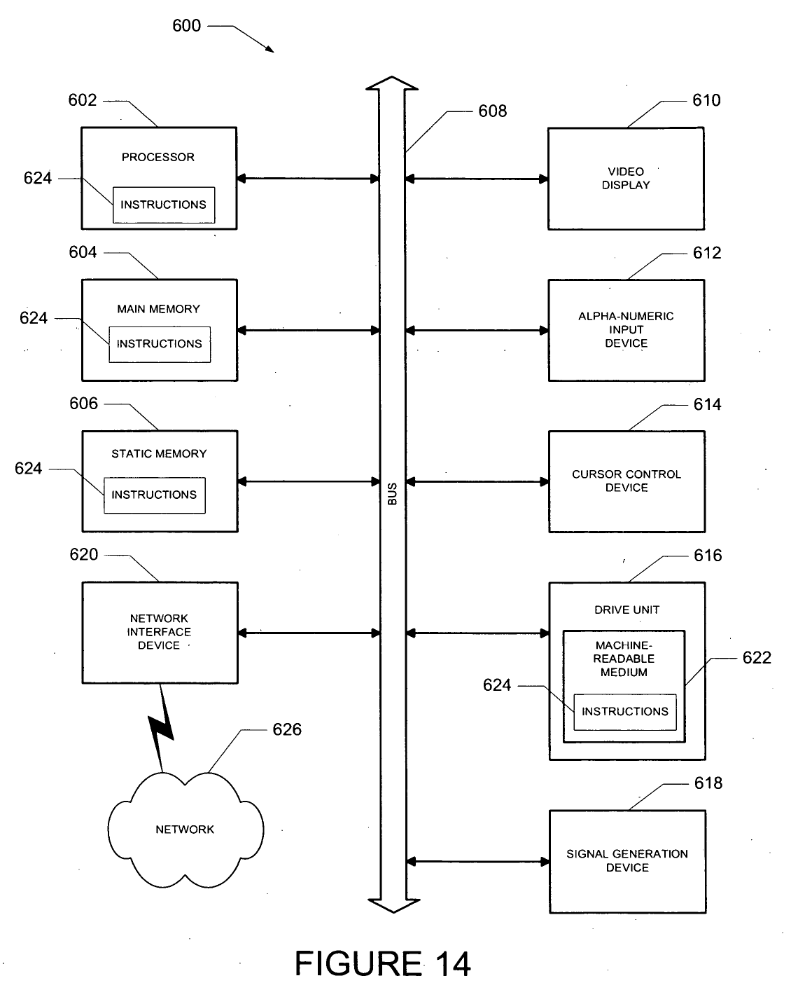

FIG. 14 shows a diagrammatic representation of machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” may also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620 utilizing any one of a number of well-known transfer protocols (e.g., HTTP).

While the machine-readable medium 622 is shown in an example embodiment to be a single medium, the term “machine-readable medium” may be taken to include a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” may accordingly be taken to include, but not be limited to, solid-state memories, optical and magnetic media, and carrier wave signals. Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A computer-implemented method to obtain relative frequency distributions to forecast counts used in worker scheduling, the computer-implemented method comprising:
calculating a plurality of square roots of count data associated with a sequence of the plurality of intervals;
extracting a number of amplitudes associated with a plurality of count distributions from the calculated plurality of square roots;
calculating a number of counts associated with each amplitude over the plurality of intervals; and
squaring the extracted number of amplitudes to obtain a corresponding plurality of estimates of relative frequency distributions describing the distribution of the calculated number of counts over the plurality of intervals.

2. The computer-implemented method of claim 1 wherein the counts are selected from a group including events, transactions, requests for service, contacts arriving at a system for handling contacts, and arriving customers.

3. The computer-implemented method of claim 1 wherein the plurality of intervals are selected from a group including intervals of time, intervals of space, intervals of cyber-space, business abstractions that can be formulated as measurable subsets in a measured space, and subsets in a space of business abstractions, which abstractions are used to at least one of describe, define, and classify different types of counts.

4. The computer-implemented method of claim 3 wherein the plurality of intervals are ordered pairs of any two from the group.

5. The computer-implemented method of claim 1 wherein each of the calculated counts of the number of calculated counts includes a total number of counts, due to the respective amplitude, summed over the sequence.

6. The computer-implemented method of claim 1 further comprising normalizing the plurality of estimates of the relative frequency distributions to obtain estimates of probability distributions describing distribution of the calculated number of counts over the plurality of intervals.

7. The computer-implemented method of claim 6 wherein normalizing the relative frequency distributions includes dividing each of the numbers of the amplitude by a positive constant to obtain another set of numbers, wherein the numbers of the probability distribution sum to one.

8. The computer-implemented method of claim 6 wherein the amplitude is selected to render normalization as substantially dispensable.

9. The computer-implemented method of claim 1 wherein the plurality of intervals are associated with intervals of time and each time interval is of substantially constant duration, wherein each time interval is organized into a same number of blocks.

10. The computer-implemented method of claim 9 wherein squaring the numbers of the amplitude for each interval of a block gives the relative frequency with which counts assigned to that amplitude occur on that interval of a block.

11. The computer-implemented method of claim 9 wherein each time interval is selected from a period of a day, a day, a period of a week, a week, a period of a month, and a month.

12. The computer-implemented method of claim 9 wherein the sequence of the plurality of intervals includes a Cartesian product of two selected from a group including a set of time intervals, a set of locations, and a set of locations in cyber-space, a type of count, a set of types that defines a classification of different kinds of counts, a measurable set in a first measure space and a measurable set in a second measure space.

13. A machine-readable medium storing a sequence of instructions that, when executed by a computer, cause the computer to perform the computer-implemented method of claim 1.

14. A system to obtain relative frequency distributions to forecast counts used in worker scheduling, the system comprising:
means for calculating a plurality of square roots of count data associated with a sequence of the plurality of intervals;
means for extracting a number of amplitudes associated with a plurality of count distributions from the calculated plurality of square roots;
means for calculating a number of counts associated with each amplitude over the plurality of intervals; and
means for squaring the extracted number of amplitudes to obtain a corresponding plurality of estimates of relative frequency distributions describing the distribution of the calculated number of counts over the plurality of intervals.

15. The system of claim 14 wherein the means for calculating a number of counts associated with each amplitude includes a solution for an eigenvalue-eigenvector mathematical problem, wherein the means for calculating a plurality of square roots, the means for extracting, the means for calculating a number of counts, and the means for squaring include a probability distribution module.

16. A system to obtain relative frequency distributions to forecast counts used in worker scheduling, the system comprising:
a probability distribution module:
to calculate a plurality of square roots of count data associated with a sequence of the plurality of intervals;
to extract a number of amplitudes associated with a plurality of count distributions from the calculated plurality of square roots;
to calculate a number of counts associated with each amplitude over the plurality of intervals; and
to square the extracted number of amplitudes to obtain a corresponding plurality of estimates of relative frequency distributions describing the distribution of the calculated number of counts over the plurality of intervals.

17. The system of claim 16 wherein the counts are selected from a group including events, contacts, requests for service, contacts arriving at a system for handling contacts, and arriving customers.

18. The system of claim 16 wherein the plurality of intervals are selected from a group including intervals of time, intervals of space, intervals of cyber-space, business abstractions that can be formulated as measurable subsets in a measured space, and subsets in a space of business abstractions, which abstractions are used to at least one of describe, define, and classify different types of counts.

19. The system of claim 18 wherein the plurality of intervals are ordered pairs of any two from the group.

20. The system of claim 16 wherein each of the calculated counts of the number of calculated counts includes a total number of counts, due to the respective amplitude, summed over the sequence.

21. The system of claim 16 wherein the plurality of intervals are associated with intervals of time and each time interval is of substantially constant duration, wherein each time interval is organized into a same number of blocks.

22. The system of claim 21 wherein the sequence of the plurality of intervals includes a Cartesian product of two selected from a group including a set of time intervals, a set of locations, and a set of locations in cyber-space, a type of count, a set of types that defines a classification of different kinds of counts, a measurable set in a first measure space and a measurable set in a second measure space.
